(19) United States
(12) Patent Application Publication
(10) Pub. No.: US 2011/0271182 A1
(43) Pub. Date: Nov. 3, 2011

(54) ELETRONIC APPARATUS AND CONTROL METHOD THEREOF

(75) Inventors: CHIEH-CHIH TSAI, TAIPEI (TW); YU-MAO FENG, TAIPEI (TW)

(73) Assignee: ACER INCORPORATED, TAIPEI COUNTY (TW)

(21) Appl. No.: 12/770,708

(22) Filed: Apr. 29, 2010

(51) Int. Cl. G06F 3/048; G06F 3/01

(52) U.S. Cl. 715/702; 715/769; 715/835

(57) ABSTRACT

The present invention discloses an electronic apparatus and a control method thereof. The electronic apparatus comprises a touch-controlled panel and a control module, and the control method comprises the steps of: touching and dragging at least one icon shown on the touch-controlled panel to a page-indexing row, the page-indexing row comprising a plurality of number indexes, and each number index representing a page; determining whether the icon is dragged to the site of one of the number index shown in the page-indexing row by the control module; focusing the number index when the icon is dragged to the site of one of the number index; determining whether the icon is touched at the site of the focused number index by the control module; moving the icon to a page represented by the focused number index when the icon is not touched at the site of the focused number index.

### FIELD

The exemplary embodiment(s) of the present invention relates to a field of electronic apparatus and control method thereof. More specifically, the exemplary embodiment(s) of the present invention relates to an electronic apparatus and control method thereof that quickly moves the icons between pages.

### BACKGROUND

Please refer to FIG. 1, which is a schematic diagram that illustrates the conventional method moving icons between pages. The application programs in conventional smart phones are designed and represented by different icons, and the smart phone executes the corresponding application program when a user clicks one of the icons. As the number of the application programs grows, there is not enough space to accommodate these icons. So more than one pages are need to arrange these icons.

As shown in FIG. 1, the conventional method moving icons between pages includes touching one of the icons then dragging the icon to the edge of the display of the smart phone. At the same time, the smart phone displays the next page or the previous page so the user can move the icon from original page to another page. However, as the number of the pages grows, for example 30 pages, then the user has to continually touch the icon at the edge of the display of the smart phone and wait for page-changing for 15 times when the user want to move the icon from page 15 to page 30 regardless forwardly or backwardly, and this does cause the inconvenience for the user to use the smart phone.

### SUMMARY

To solve the problems in the conventional arts, it is a primary object of the present invention to provide an electronic apparatus and a control method thereof to solve the problem that a user need to wait for a long time to move an icon from one page to another.

To achieve the above object, an electronic apparatus according to the present invention comprises a touch-controlled panel and a control module. The touch-controlled panel displays a plurality of icons and a page-indexing row. The page-indexing row comprises a plurality of number indexes, and each number index represents a page. The control module determines whether one of the icons is dragged to the site of one of the number index shown in the page-indexing row, and focuses the number index when the icon is dragged to the site of one of the number index. The control module further determines whether the icon is touched at the site of the focused number index, and moves the icon to a page represented by the focused number index when the icon is not touched at the site of the focused number index.

Wherein before determining whether the icon is touched at the site of the focused number index, the control module further determines whether the icon is dragged away from the site of the focused number index, and defocuses the focused number index when the icon is dragged away from the focused number index.

Wherein an application program is executed by the control module when one of the icons is clicked.

Wherein the electronic apparatus is a mobile wireless communication apparatus or a personal digital assistant (PDA).

To achieve the above object, an electronic apparatus control method according to the present invention is further provided. The electronic apparatus comprises a touch-controlled panel and a control module, and method comprises the following steps of: touching and dragging at least one icon shown on the touch-controlled panel to a page-indexing row, the page-indexing row comprising a plurality of number indexes, and each number index representing a page; determining whether the icon is dragged to the site of one of the number index shown in the page-indexing row by the control module; focusing the number index when the icon is dragged to the site of one of the number index; determining whether the icon is touched at the site of the focused number index by the control module; moving the icon to a page represented by the focused number index when the icon is not touched at the site of the focused number index.

Wherein before the step of determining whether the icon is touched at the site of the focused number index, the electronic apparatus control method further comprises the following steps of: determining whether the icon is dragged away from the site of the focused number index by the control module; defocusing the focused number index when the icon is dragged away from the focused number index by the control module.

Wherein an application program is executed by the control module when one of the icons is clicked.

Wherein the electronic apparatus is a mobile wireless communication apparatus or a personal digital assistant (PDA).

With the above arrangements, the electronic apparatus and the control method thereof according to the present invention have the following advantage of that the electronic apparatus and the control method thereof could increase the convenience while arranging a plurality of icons between a plurality of pages by dragging the icons to a specific number index and releasing the icon at the site of the number index to move the icon to the page represented by the number index.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram that illustrates the conventional method moving icons between pages;

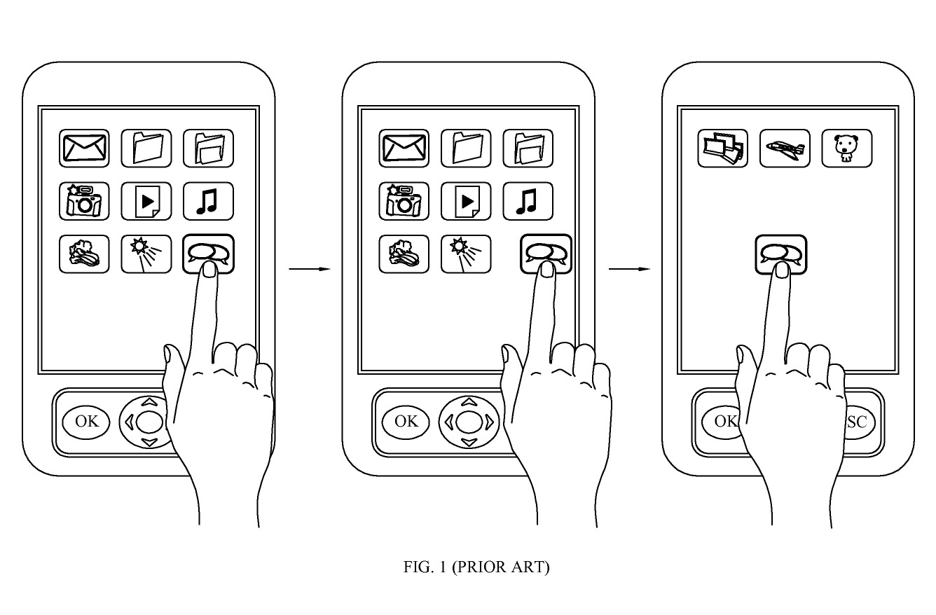

FIG. 2 is a schematic diagram of an embodiment in accordance with the present invention;

FIG. 3 is another schematic diagram of an embodiment in accordance with the present invention;

FIG. 4 is a flow chart of an electronic apparatus control method in accordance with the present invention; and

FIG. 5 is another flow chart of an electronic apparatus control method in accordance with the present invention.

### DETAILED DESCRIPTION

Exemplary embodiments of the present invention are described herein in the context of an illuminating system and a method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

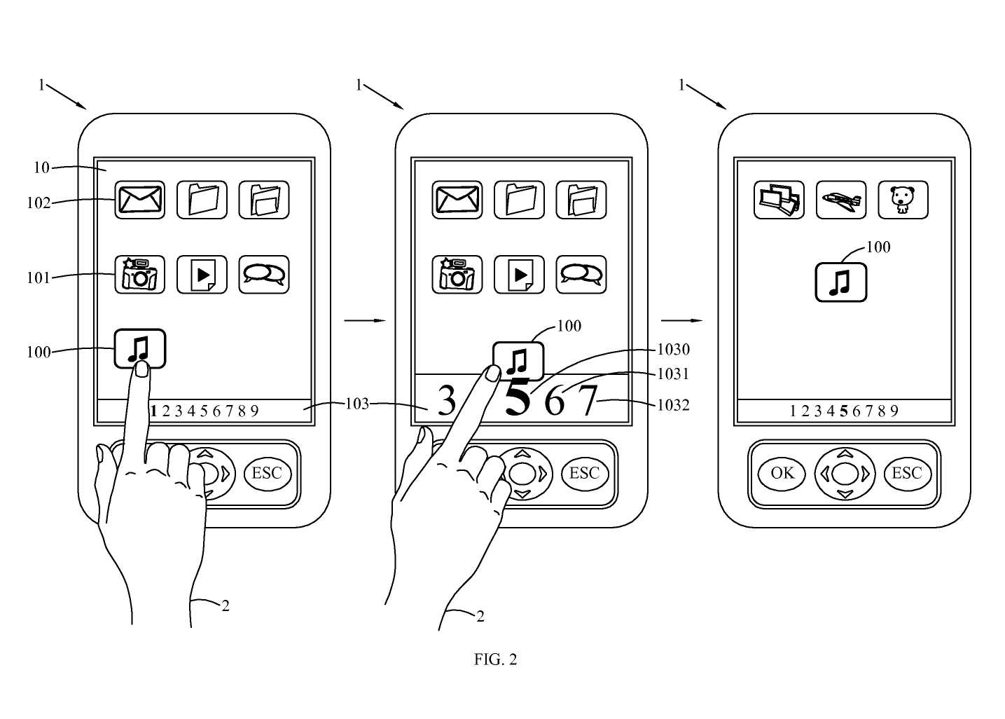

Please refer to FIG. 2, which is a schematic diagram of an embodiment in accordance with the present invention. As shown in this figure, the electronic apparatus 1 according to the present invention comprises a touch-controlled panel 10 and a control module (not show in the figure). The electronic apparatus 1 could be a mobile wireless communication apparatus or a personal digital assistant (PDA). The touch-controlled panel 10 displays a plurality of icons (100, 101 and 102) and a page-indexing row 103, and a corresponding application program is executed by the control module when one of the icons is clicked. The page-indexing row 103 comprises a plurality of number indexes (1030, 1031 and 1032), and each number index (1030, 1031 and 1032) represents a page. In this embodiment, when a user 2 touches one of the icons (100, 101 and 102) in page one (for example, icon 100), then the control module starts to determine whether the icon 100 is dragged to the site of one of the number index (1030, 1031 and 1032) shown in the page-indexing row (for example, number index 1030), and focuses the number index 1030 when the icon 100 is dragged to the site of the number index 1030. The control module further determines whether the icon 100 is touched at the site of the focused number index 1030, and moves the icon 100 to a page (i.e., page five) represented by the focused number index 1030 when the icon 100 is not touched (i.e., be released by the user 2) at the site of the focused number index 1030.

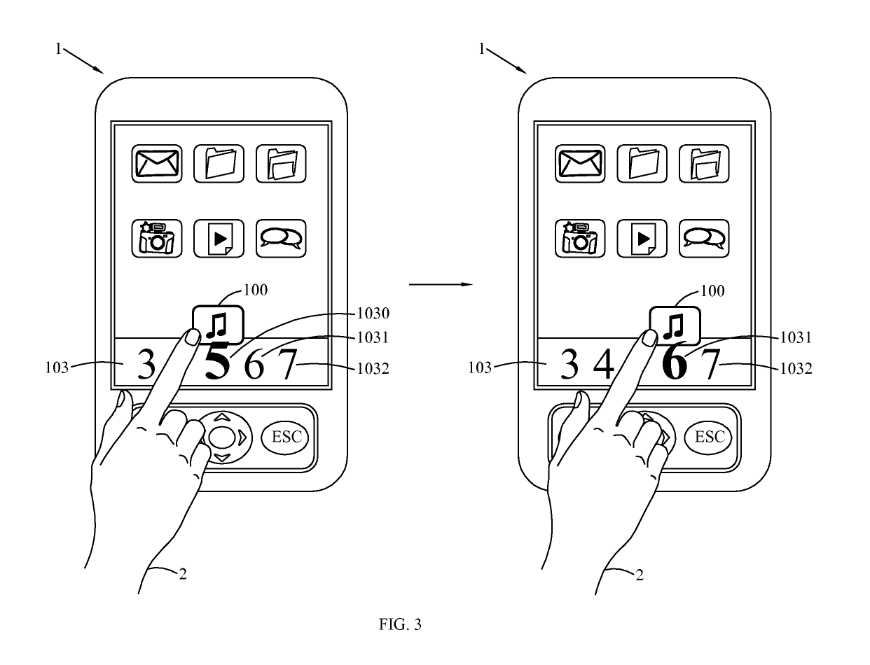

Please refer to FIG. 3, which is another schematic diagram of an embodiment in accordance with the present invention. As shown in this figure, before determining whether the icon 100 is touched at the site of the focused number index 1030, the control module further determines whether the icon 100 is dragged away from the site of the focused number index 1030, and defocuses the focused number index 1030 when the icon 100 is dragged away from the focused number index 1030. At this time, if the user drags the icon 100 to the site of the index number 1031 which represents the page six, then the number index 1031 will be focused according to the way aforementioned. The way to focus the number indexes includes lightening the number indexes, twinkling the number indexes, zooming in the number indexes or the combining the ways aforesaid.

The concept of the electronic apparatus control method in accordance to the present invention is described together with the description of the electronic apparatus disclosed in the present invention, but in order to get clearer, the following will still illustrate the flow chart of the electronic apparatus control method.

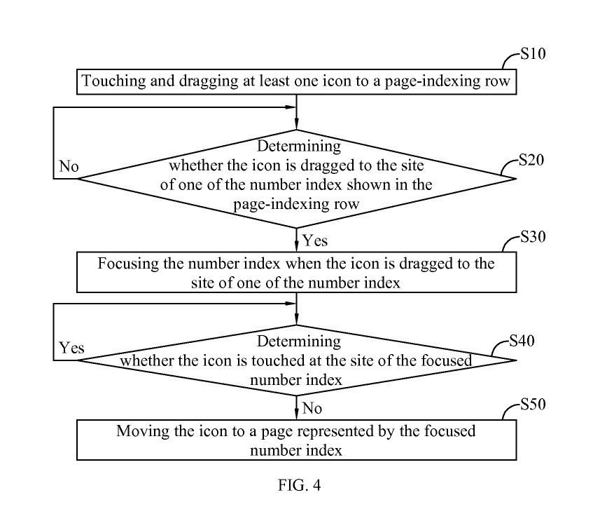

Please refer to FIG. 4, which is a flow chart of an electronic apparatus control method in accordance with the present invention. The electronic apparatus comprises a touch-controlled panel and a control module, and the control method comprising the following steps of: (S10) touching and dragging at least one icon shown on the touch-controlled panel to a page-indexing row, the page-indexing row comprising a plurality of number indexes, and each number index representing a page; (S20) determining whether the icon is dragged to the site of one of the number index shown in the page-indexing row by the control module; (S30) focusing the number index when the icon is dragged to the site of one of the number index; (S40) determining whether the icon is touched at the site of the focused number index by the control module; (S50) moving the icon to a page represented by the focused number index when the icon is not touched at the site of the focused number index. In addition, an application program is executed by the control module when one of the icons is clicked.

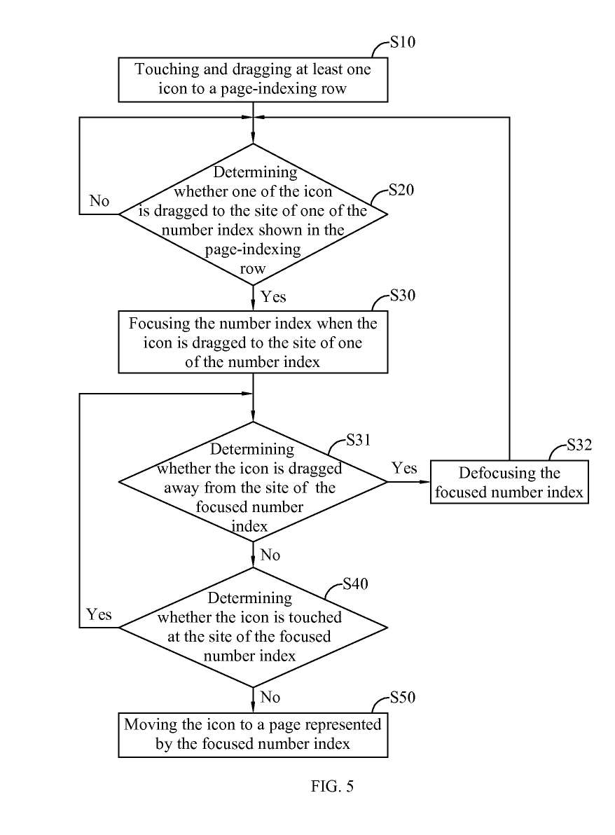

Please refer to FIG. 5, which is another flow chart of an electronic apparatus control method in accordance with the present invention. As shown in this figure, before step (S40), the control method according to the present invention further comprises the following steps of: (S31) determining whether the icon is dragged away from the site of the focused number index by the control module; (S32) defocusing the focused number index when the icon is dragged away from the focused number index by the control module.

The implementation of the electronic apparatus control method in accordance with the present invention has already described in the description of the embodiments of the electronic apparatus according to the present invention, so it will not be stated here again.

The electronic apparatus and the control method thereof could increase the convenience while arranging a plurality of icons between a plurality of pages by dragging the icons to a specific number index and releasing the icon at the site of the number index to move the icon to the page represented by the number index.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An electronic apparatus, comprising:
a touch-controlled panel displaying a plurality of icons and a page-indexing row, the page-indexing row comprising a plurality of number indexes, and each number index representing a page; and
a control module determining whether one of the icons is dragged to the site of one of the number index shown in the page-indexing row, and focusing the number index when the icon is dragged to the site of one of the number index, and determining whether the icon is touched at the site of the focused number index by the control module, and moving the icon to a page represented by the focused number index when the icon is not touched at the site of the focused number index.

2. The electronic apparatus of claim 1, wherein before determining whether the icon is touched at the site of the focused number index, the control module further determines whether the icon is dragged away from the site of the focused number index, and defocuses the focused number index when the icon is dragged away from the focused number index.

3. The electronic apparatus of claim 2, wherein an application program is executed by the control module when one of the icons is clicked.

4. The electronic apparatus of claim 3, wherein the electronic apparatus is a mobile wireless communication apparatus or a personal digital assistant (PDA).

5. An electronic apparatus control method, the electronic apparatus comprising a touch-controlled panel and a control module, and the method comprising:
touching and dragging at least one icon shown on the touch-controlled panel to a page-indexing row, the page-indexing row comprising a plurality of number indexes, and each number index representing a page;
determining whether the icon is dragged to the site of one of the number index shown in the page-indexing row by the control module;
focusing the number index when the icon is dragged to the site of one of the number index;
determining whether the icon is touched at the site of the focused number index by the control module; and
moving the icon to a page represented by the focused number index when the icon is not touched at the site of the focused number index.

6. The electronic apparatus control method of claim 5, wherein before the step of determining whether the icon is touched at the site of the focused number index, the electronic apparatus control method further comprises:
determining whether the icon is dragged away from the site of the focused number index by the control module; and
defocusing the focused number index when the icon is dragged away from the focused number index by the control module.

7. The electronic apparatus control method of claim 6, wherein an application program is executed by the control module when one of the icons is clicked.

8. The electronic apparatus control method of claim 7, wherein the electronic apparatus is a mobile wireless communication apparatus or a personal digital assistant (PDA).
